(19) United States
(12) Patent Application Publication
(10) Pub. No.: US 2025/0017149 A1
(43) Pub. Date: Jan. 16, 2025

(54) HORTICULTURE CONTAINER SYSTEMS AND METHODS

(71) Applicant: Zack Zeiset, Salida, CO (US)

(72) Inventor: Zack Zeiset, Salida, CO (US)

(21) Appl. No.: 18/372,537

(22) Filed: Sep. 25, 2023

Related U.S. Application Data
(60) Provisional application No. 63/526,829, filed on Jul. 14, 2023.

(51) Int. Cl. A01G 9/029

(52) U.S. Cl. CPC A01G 9/0291

(57) ABSTRACT

Container devices for use with planting assemblies are disclosed. Exemplary container devices include a sleeve for receiving at least a portion of a planting apparatus of the planting assembly, and multiple corner supports that contact a bottom portion of the planting apparatus. Container devices can be used for storing, transporting, and shipping the planting assemblies.

### CROSS-REFERENCES TO RELATED APPLICATIONS

This application claims the benefit of U.S. Provisional Patent Application No. 63/526,829 filed Jul. 14, 2023, the disclosure of which is incorporated herein by reference.

### BACKGROUND OF THE INVENTION

Embodiments of the present invention relate generally to horticulture systems and methods, and in particular encompass containers for holding plants, potting media, and various combinations thereof.

### BRIEF SUMMARY OF THE INVENTION

Exemplary embodiments encompass container devices and methods for supporting, holding, storing, and/or transporting plant and/or potting media elements.

In a first aspect, embodiments of the present invention encompass container devices for holding or supporting planting assemblies. An exemplary container device can include a number of side panels. In some cases, a container device can include four side panels, such as a first side panel, a second side panel, a third side panel, and a fourth side panel. A container device can also include a number of corner supports. In some cases, a container device can include four corner supports, such as a first corner support, a second corner support, a third corner support, and a fourth corner support. In some cases, the first side panel, the second side panel, the third side panel, and the fourth side panel define an interior space configured to receive at least part of the planting assembly. In some cases, the first corner support, the second corner support, the third corner support, and the fourth corner support are configured to contact and support a planting apparatus of the planting assembly. In some cases, the first corner support is defined at least in part by a curved cut. In some cases, the first corner support includes a folded diamond shape. In some cases, the folded diamond shape includes a seam disposed between a first triangle half and a second triangle half, where the first triangle half includes a first base disposed along the seam, a first side, and a second side, and where the second triangle half includes a second base disposed along the seam, a first side, and a second side. In some cases, the first side of the first triangle half has a lower portion that connects with a lower portion of the first side panel, and the first side of the second triangle half has a lower portion that connects with a lower portion of the second side panel. In some cases, the first side of the first triangle half has a lower portion that connects with a central portion of the first side panel that is disposed above a lower portion of the first side panel, and the first side of the second triangle half has a lower portion that connects with a central portion of the second side panel that is disposed above a lower portion of the second side panel. In some cases, a container device further includes a platform that is supported by corner supports. For example, a platform can be supported by a first corner support, a second corner support, a third corner support, and a fourth corner support.

In another aspect, embodiments of the present invention include a plant system having a plant and a potting apparatus. A potting apparatus can include a sleeve and a plug of potting media. Roots of the plant can be disposed or positioned at least partially within the sleeve and can pass through one or more apertures of the sleeve. A plant system can also include a container device, and the container device can at least partially contain the planting assembly. An exemplary container device can include a number of side panels. In some cases, a container device can include four side panels, such as a first side panel, a second side panel, a third side panel, and a fourth side panel. A container device can also include a number of corner supports. In some cases, a container device can include four corner supports, such as a first corner support, a second corner support, a third corner support, and a fourth corner support. In some cases, the first side panel, the second side panel, the third side panel, and the fourth side panel define an interior space configured to receive at least part of the planting assembly. In some cases, the first corner support, the second corner support, the third corner support, and the fourth corner support are configured to contact and support a planting apparatus of the planting assembly. In some cases, the first corner support is defined at least in part by a curved cut. In some cases, the first corner support includes a folded diamond shape. In some cases, the folded diamond shape includes a seam disposed between a first triangle half and a second triangle half, where the first triangle half includes a first base disposed along the seam, a first side, and a second side, and where the second triangle half includes a second base disposed along the seam, a first side, and a second side. In some cases, the first side of the first triangle half has a lower portion that connects with a lower portion of the first side panel, and the first side of the second triangle half has a lower portion that connects with a lower portion of the second side panel. In some cases, the first side of the first triangle half has a lower portion that connects with a central portion of the first side panel that is disposed above a lower portion of the first side panel, and the first side of the second triangle half has a lower portion that connects with a central portion of the second side panel that is disposed above a lower portion of the second side panel. In some cases, a container device further includes a platform that is supported by corner supports. For example, a platform can be supported by a first corner support, a second corner support, a third corner support, and a fourth corner support.

In still another aspect, embodiments of the present invention include methods for producing or manufacturing a plant system. For example, methods may include placing a planting assembly at least partially within a container device. An exemplary container device can include a number of side panels. In some cases, a container device can include four side panels, such as a first side panel, a second side panel, a third side panel, and a fourth side panel. A container device can also include a number of corner supports. In some cases, a container device can include four corner supports, such as a first corner support, a second corner support, a third corner support, and a fourth corner support. In some cases, the first side panel, the second side panel, the third side panel, and the fourth side panel define an interior space configured to receive at least part of the planting assembly. In some cases, the first corner support, the second corner support, the third corner support, and the fourth corner support are configured to contact and support a planting apparatus of the planting assembly. In some cases, the first corner support is defined at least in part by a curved cut. In some cases, the first corner support includes a folded diamond shape. In some cases, the folded diamond shape includes a seam disposed between a first triangle half and a second triangle half, where the first triangle half includes a first base disposed along the seam, a first side, and a second side, and where the second triangle half includes a second base disposed along the seam, a first side, and a second side. In some cases, the first side of the first triangle half has a lower portion that connects with a lower portion of the first side panel, and the first side of the second triangle half has a lower portion that connects with a lower portion of the second side panel. In some cases, the first side of the first triangle half has a lower portion that connects with a central portion of the first side panel that is disposed above a lower portion of the first side panel, and the first side of the second triangle half has a lower portion that connects with a central portion of the second side panel that is disposed above a lower portion of the second side panel. In some cases, a container device further includes a platform that is supported by corner supports. For example, a platform can be supported by a first corner support, a second corner support, a third corner support, and a fourth corner support.

These and other embodiments are described in further detail in the following description related to the appended drawing figures.

### BRIEF DESCRIPTION OF THE DRAWINGS

Specific embodiments of the disclosed devices, horticulture systems, or methods will now be described with reference to the drawings. Nothing in this detailed description is intended to imply that any particular component, feature, or step is essential to the invention.

FIG. 1 depicts aspects of planting assemblies and container devices, according to embodiments of the present invention.

FIGS. 2A to 2C depict aspects of a container device, according to embodiments of the present invention.

FIGS. 3A to 3E depict aspects of a container device, according to embodiments of the present invention.

FIG. 4 depicts aspects of unfolded container blanks and container devices, according to embodiments of the present invention.

FIG. 5 depicts aspects of a manufacturing machine that is used to fabricate a container device, according to embodiments of the present invention.

FIG. 6 depicts aspects of a manufacturing machine that is used to fabricate a container device, according to embodiments of the present invention.

FIG. 7 depicts aspects of a manufacturing machine that is used to fabricate a container device, according to embodiments of the present invention.

FIG. 8 depicts aspects of a manufacturing machine that is used to fabricate a container device, according to embodiments of the present invention.

### DETAILED DESCRIPTION OF THE INVENTION

Currently available horticulture containers are expensive and manufactured from unsustainable sources. Although existing containers may be useful, still further improvements are desired. Embodiments of the present invention provide solutions for at least some of these outstanding needs.

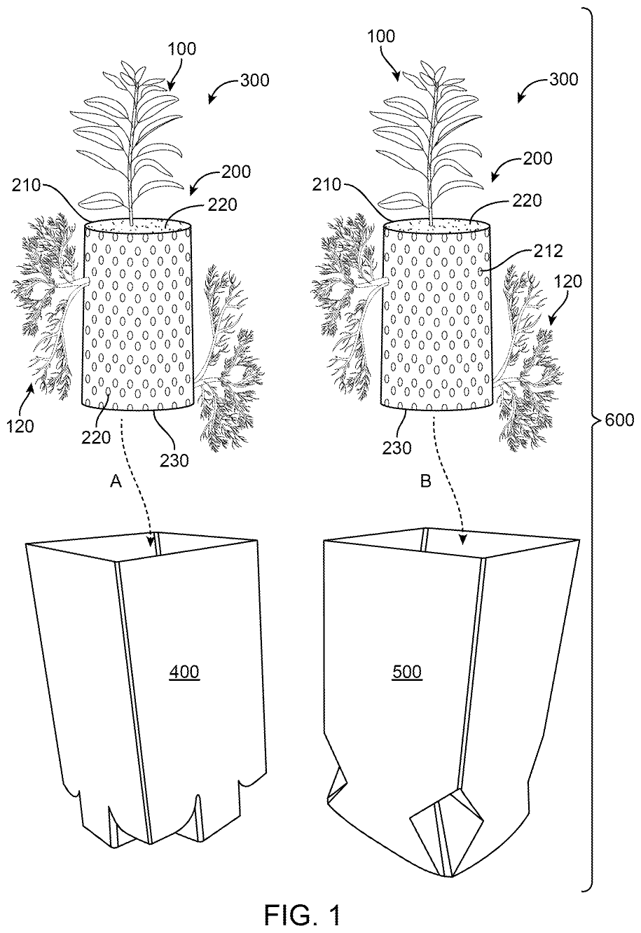

Turning now to the drawings, FIG. 1 depicts aspects of exemplary containers and related methods as disclosed herein. As shown here, a sprouted plant 100 is positioned in a potting apparatus 200. The potting apparatus 200 includes a sleeve 210 wrapped about a plug of potting media 220. As shown here, the potting apparatus 200 includes a bottom section 230. The sleeve 210 includes apertures 212 through which roots 120 of the plant 100 can extend. In some instances, the sleeve 200 includes or is fabricated from a paper material. The sleeve material can be water permeable, air permeable, and/or root permeable. In combination, a plant 100 and potting apparatus 200 can constitute a planting assembly 300. As shown here, a planting assembly 300 can be placed within a container device, such as container 400 or container 500, as indicated by arrows A and B, respectively. The container can facilitate healthy functioning of the planting assembly 300, which may include cuttings, seeds, sprouted seedlings, stock plants including fruits and vegetables, forestry plants, and the like.

In use, individual planting assemblies can be placed in respective containers, and positioned adjacent to one another, and the containers can operate to prevent the roots from one planting assembly from coming in contact with or growing together with roots from an adjacent planting assembly. In some instances, a grower or horticulturist can prepare the potting apparatus, grow a plant in it (e.g. in a greenhouse), and then place the resulting planting assembly 300 in a container (e.g. 400 or 500) to provide a plant system 600. In some instances, the grower may purchase the container from a separate party. The grower or horticulturist may then sell the system 600 as a unit (e.g. planting assembly 300 combined with container 400 or 500). The system 600 as a unit exhibits an aesthetically pleasing appearance for retail consumption. In this sense, the container can operate as an aid for sales of the plant or planting assembly, and advantageously, the container can also operate as an aid for transportation of the plant or planting assembly. In some instances, a container can be sold as a retail item. The container can operate to prevent damage to the roots during shipping or handling, which is particularly useful because ripped or damaged roots may not recover. The container also provides a protective effect to the planting assembly during the propagation and/or planting or growing process (e.g. which may occur at a vineyard or other propagation or planting location). In some instances, advertising information or logos can be printed on the container. In some instances, the container provides a protective effect to the planting assembly during shipping to an intermediate or final location, such as a retail nursery. The protective effect of the container can facilitate healthy root development and/or minimize shock which may otherwise be experienced by the plant during shipping and/or transplanting. The container can help prevent the planting assembly from water damage.

A container device, such as container device 400 or container device 500, can be manufactured from or include any of a variety of paper or paper-like or sheet-like materials. In some instances, a container device can be fabricated with a heat sealable non-polyethylene coated paperboard material. In some cases, a container device can be fabricated with a non-plastic heat sealable paper material. In some cases, a container device can be manufactured from a plastic-free paperboard material. In some cases, a container device can include a paper product that is manufactured from natural wood sources, and that does not include any plastic polymer additions. In some cases, a container device can be manufactured from a paper or sheet material that is recyclable and/or compostable.

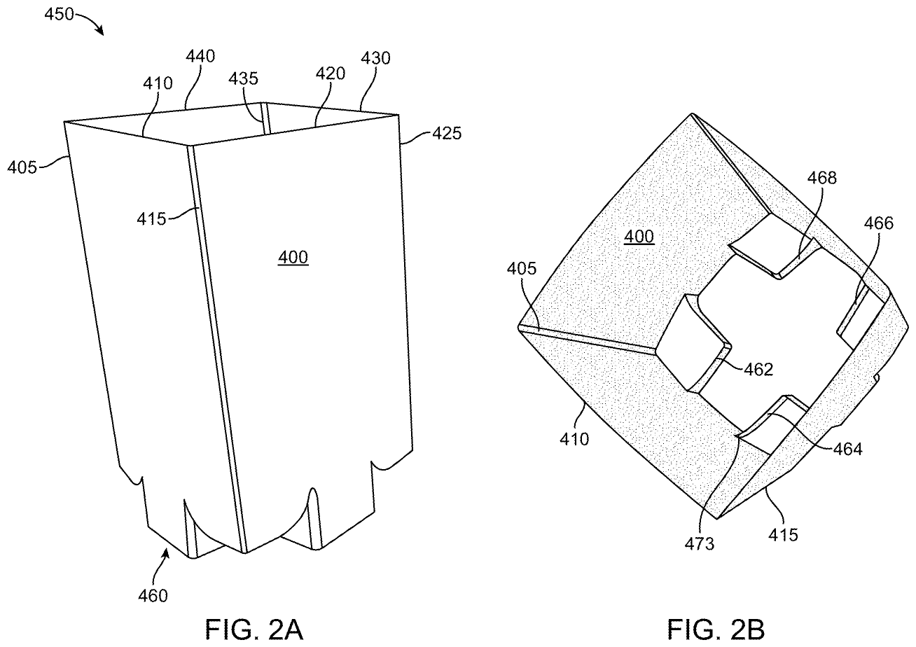

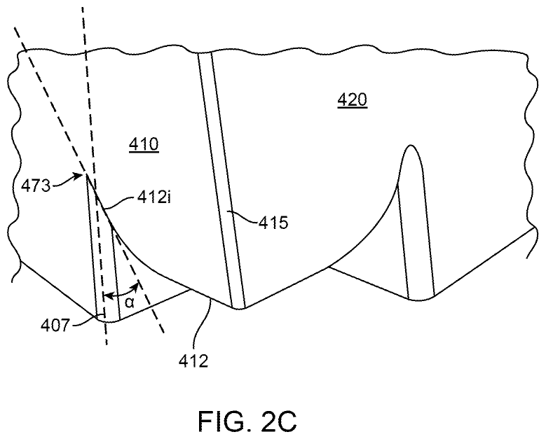

FIG. 2A provides a side perspective view of container device 400. FIG. 2B provides a top perspective view of container device 400. As shown here, device 400 includes four side panels (410, 420, 430, 440) with corresponding corner edges (405, 415, 425, 435) between adjacent sides. The device has a top section 450 and a bottom section 460. In each corner of the bottom section 460, there is a corner support (462, 464, 466, 468) corresponding to each corner edge. The corner supports operate to support the planting assembly (e.g. 300 shown in FIG. 1) when the planting assembly is placed within the container. For example, a bottom section of a potting apparatus may rest upon the corner supports. The corner supports are formed by creating connected cuts in adjacent side panels. In some cases, two adjacent connected cuts can be cut simultaneously, for example using a die cutting process.

As shown in FIG. 2C, the cut 412 in side panel 410 is configured so that an inner portion 412i of the cut forms an angle α with inner corner edge 407 of side panel 410. The angle α is less than 90°, which advantageously provides a strong connection point 473 between the panel 410 and the support 464 as shown in FIG. 2B. In other words, by providing a curved or contoured cut 412 in this way, it is possible to reduce stress at a location (e.g. 473) where the inner corner edge or fold 407 joins the cut 412. If cut 412 were not curved but rather a straight line perpendicular to the edge 407, then cut 412 would join the edge 407 at a 90° angle.

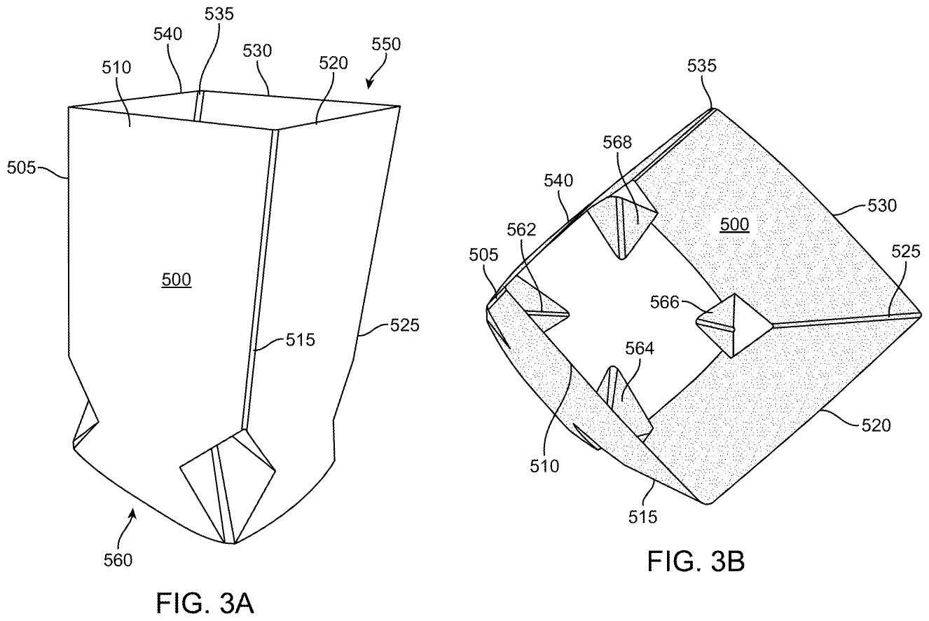

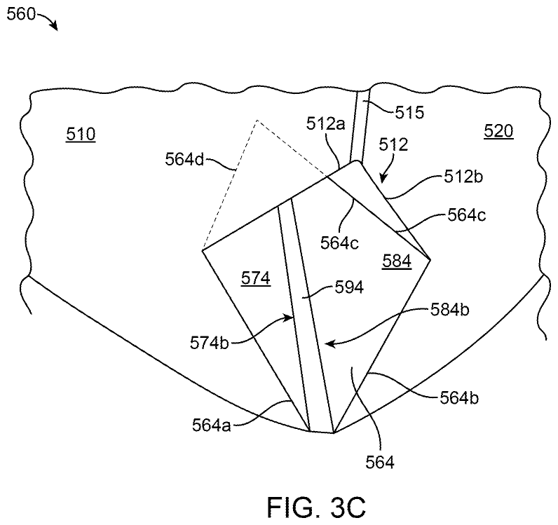

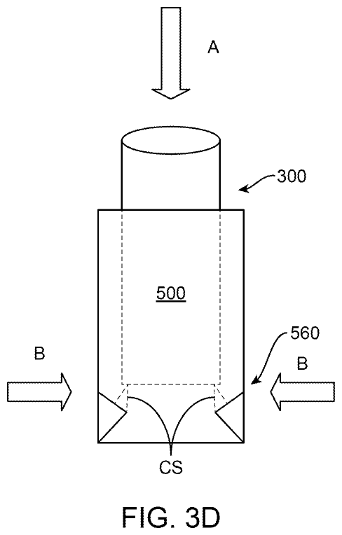

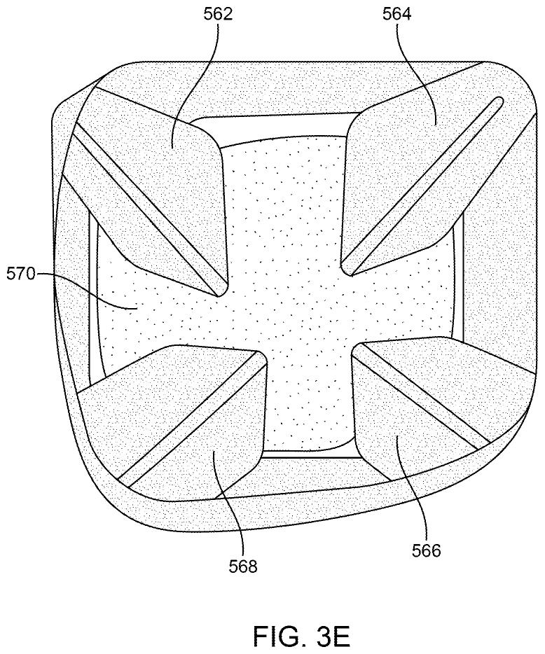

FIG. 3A provides a side perspective view of container device 500. FIG. 3B provides a top perspective view of container device 500. As shown here, device 500 includes four side panels (510, 520, 530, 540) with corresponding corner edges (505, 515, 525, 535) between adjacent sides. The device has a top section 550 and a bottom section 560. In each corner of the bottom section 560, there is a corner support (562, 564, 566, 568) corresponding to each corner edge. The corner supports operate to support the planting assembly (e.g. 300 shown in FIG. 1) when the planting assembly is placed within the container. For example, a bottom section of a potting apparatus may rest upon the corner supports. The corner supports are formed by creating connected cuts in adjacent side panels. In some cases, two adjacent connected cuts can be cut simultaneously, for example using a die cutting process.

As shown in FIG. 3C, the cut or cuts in the side panel are configured so that the corner support 564 is in the shape of a diamond, or a folded diamond. Advantageously, this configuration imparts a compression function for the container device 500, such that when a planting assembly is placed within the container 500 and pressed in a downward fashion against the corner supports (here labeled CS), the bottom section 560 in effect constricts or compresses about the planting assembly. For example, as shown in FIG. 3D, when the planting assembly 300 is pressed downward in the direction indicated by arrow A, the bottom section 560 compresses about the planting assembly 300 as indicated by arrows B. This effect is beneficial and can help to secure the positioning or placement of the planting assembly within the container.

As shown in FIG. 3C, the corner support 564 can be formed by making a cut 512 in adjacent side panels 510 and 520. In some cases, cut 512 can be made by a single cutting action. In some cases, cut 512 can be made by multiple cutting actions, for example by making a first cut 512a and a second cut 512b, whereby the first and second cuts 512a and 512b connect at corner edge 515. The diamond shape or folded diamond shape of the corner support 564 has a first side 564a, a second side 564b, a third side 564c (partially hidden, with hidden portion shown in dotted line), and a fourth side 564d (completely hidden, shown in dotted line). The corner support 564 diamond shape can be considered to have two triangle halves 574, 584. The respective bases 574b, 584b of triangle halves 574, 584 are connected by a foldable scam 594 which previously was a portion of corner edge 515.

In the embodiment shown in FIG. 3C, the bottom of support 564 coincides with the bottom of the device itself. In other embodiments, the support 564 can be positioned above the bottom of the device, so that a partial length of a corner edge (e.g. 515) is positioned below the bottom of the support 564. In other words, a support can be formed or provided at any desired location (e.g. relative to the top and/or bottom of the container) along a corner edge.

As shown in the bottom view provided by FIG. 3E, a device can include multiple corner supports 562, 564, 566, 568. In some cases, a device can also include a platform 570 which provides a supportive area for a potting apparatus. In some cases, the platform can have a curved configuration that provides contoured support for a root ball. The platform 570 can rest upon or be supported by the corner supports. The compression function discussed above also applies to this embodiment, where the platform 570 can press down upon the corner supports, for example when the weight of a potting apparatus rests upon the platform. In some cases, the platform is a removable platform or is otherwise separable or separate from the corner supports, so that its inclusion in the container device is optional.

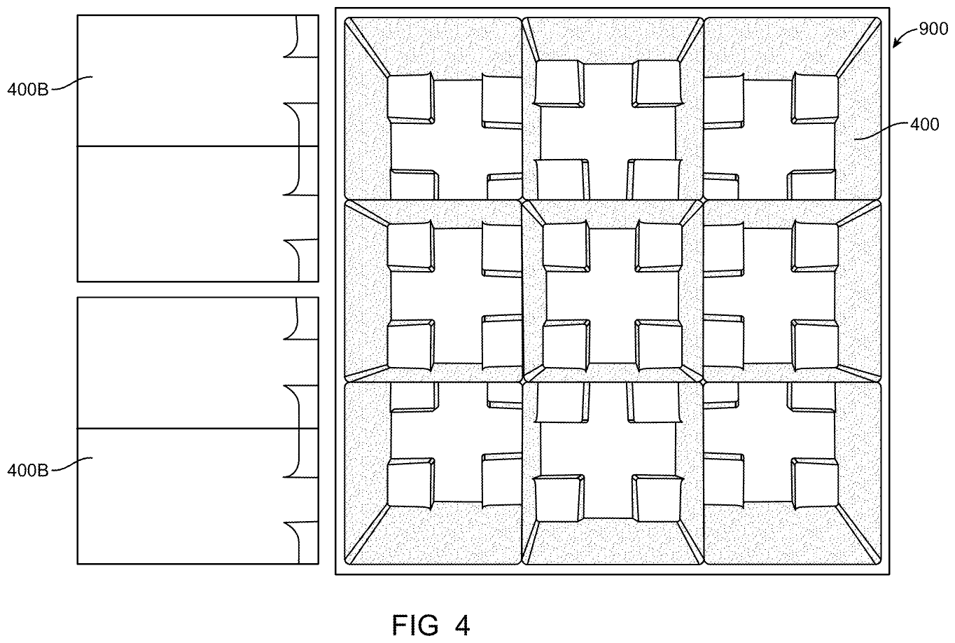

FIG. 4 provides a top plan view of two cut and unfolded container blanks 400B, each of which can be folded into container 400. FIG. 4 also illustrates how multiple (e.g. 9) containers 400 can be placed into a tray 900, which in this instance is a square tray. In some cases, the tray may be a propagation tray. In some cases, the tray may be a retail sales tray.

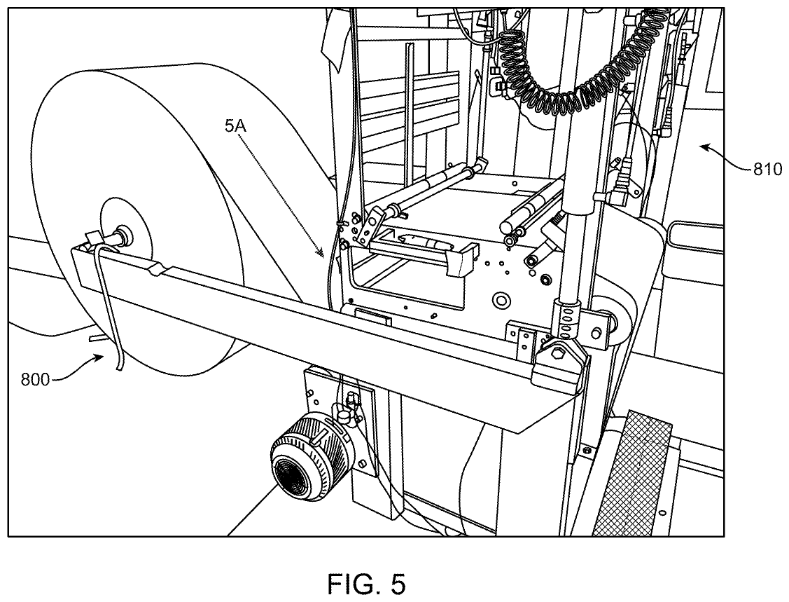

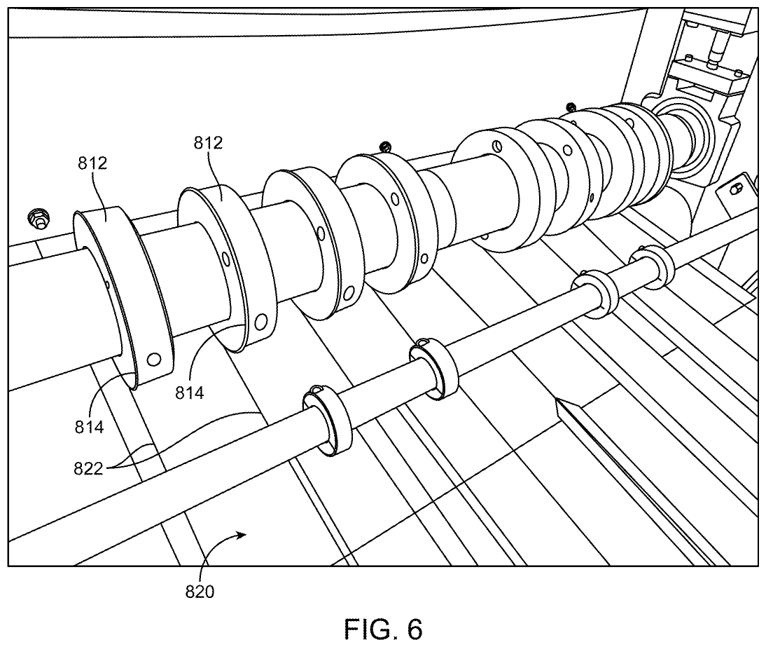

FIG. 5 illustrates aspects of a methods that involves a continuous roll of paper 800 being placed into a manufacturing machine 810 which is used during the fabrication of a container device. As shown here, a roll of paper can be unrolled, and guided through the machine 810, for example as indicated by arrow 5A. The paper can be derived or manufactured from sustainable sources. In some instances, the paper is 98% degradable and 100% recyclable.

FIG. 6 illustrates how the paper 820 can be creased, for subsequent folding. For example, the corner supports can be creased or crimped in one direction, and the corner edges can be creased or crimped in the opposite direction. In some embodiments, the corner supports can be creased or crimped in one direction, and the corner edges can be creased or crimped in the same direction. In some embodiments, creasing or crimping of corner supports and/or corner edges in one direction is sufficient to facilitate folding of the corner supports and/or corner edges in the opposite direction of the crease or crimp. In the image shown here, a manufacturing machine or other apparatus can include one or more wheels 812, and a wheel can include a creasing or crimping edge 814 that when pressed against the paper 820 forms a crease or crimp 822 in the paper. Such creases or crimps 822 can correspond to corner edges of a device, for example corner edges such as 405, 415, 425, 435 of container device 400 depicted in FIGS. 2A and 2B, or corner edges such as 505, 515, 525, 535 of container device 500 depicted in FIGS. 3A and 3B.

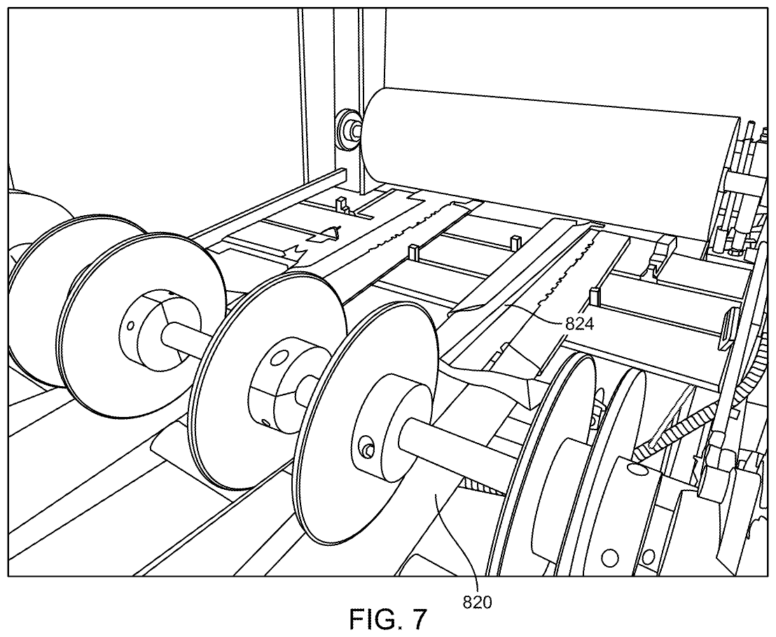

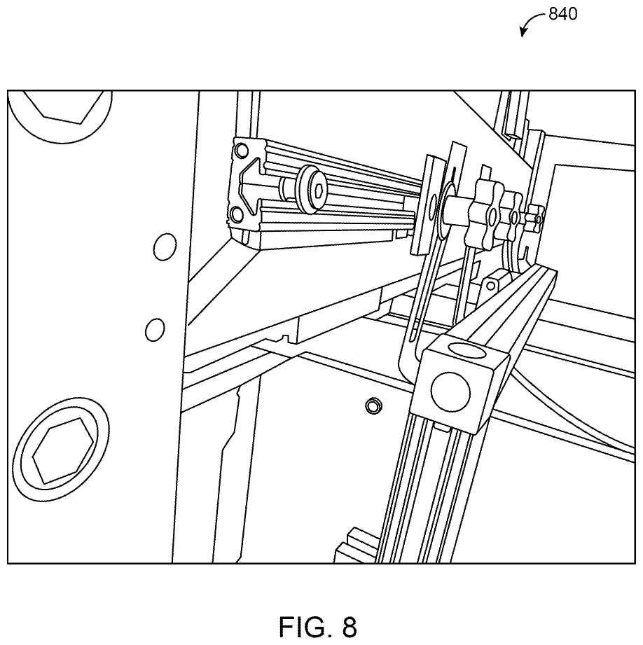

FIG. 7 depicts how a tube of paper can be heat sealed. For example, there may be a small layer of polyethylene 824 on both sides of the paper 820 that enables bonding. FIG. 8 shows a die cutter 840 that can be used to cut the container to length. In some cases, die cutter 840 can be part of a manufacturing machine, such as the manufacturing machine depicted in FIGS. 5, 6, and/or 7.

Although the preceding description contains significant detail in relation to certain preferred embodiments, it should not be construed as limiting the scope of the invention but rather as providing illustrations of the preferred embodiments.

Embodiments of the present invention encompass kits having one or more container systems as disclosed herein. In some embodiments, the kit includes one or more container system components, along with instructions for using the device(s) for example according to any of the methods disclosed herein.

All features of the described systems and devices are applicable to the described methods mutatis mutandis, and vice versa.

Although the foregoing invention has been described in some detail by way of illustration and example for purposes of clarity of understanding, one of skill in the art will appreciate that certain changes, modifications, alternate constructions, and/or equivalents may be practiced or employed as desired, and within the scope of the appended claims. In addition, each reference provided herein is incorporated by reference in its entirety to the same extent as if each reference were individually incorporated by reference. Relatedly, all publications, patents, patent applications, journal articles, books, technical references, and the like mentioned in this specification are herein incorporated by reference to the same extent as if each individual publication, patent, patent application, journal article, book, technical reference, or the like was specifically and individually indicated to be incorporated by reference.

What is claimed is:

1. A container device for a planting assembly, comprising:
a first side panel;
a second side panel;
a third side panel;
a fourth side panel;
a first corner support;
a second corner support;
a third corner support; and
a fourth corner support;
wherein the first side panel, the second side panel, the third side panel, and the fourth side panel define an interior space configured to receive at least part of the planting assembly, and
wherein the first corner support, the second corner support, the third corner support, and the fourth corner support are configured to contact and support a planting apparatus of the planting assembly.

2. The container device according to claim 1, wherein the first corner support is defined at least in part by a curved cut.

3. The container device according to claim 1, wherein the first corner support comprises a folded diamond shape.

4. The container device according to claim 3, wherein the folded diamond shape comprises a seam disposed between a first triangle half and a second triangle half, wherein the first triangle half comprises a first base disposed along the seam, a first side, and a second side, and wherein the second triangle half comprises a second base disposed along the seam, a first side, and a second side.

5. The container device according to claim 4, wherein the first side of the first triangle half has a lower portion that connects with a lower portion of the first side panel, and wherein the first side of the second triangle half has a lower portion that connects with a lower portion of the second side panel.

6. The container device according to claim 4, wherein the first side of the first triangle half has a lower portion that connects with a central portion of the first side panel that is disposed above a lower portion of the first side panel, and wherein the first side of the second triangle half has a lower portion that connects with a central portion of the second side panel that is disposed above a lower portion of the second side panel.

7. The container device according to claim 1, further comprising a platform that is supported by the first corner support, the second corner support, the third corner support, and the fourth corner support.

8. A plant system, comprising:
a planting assembly having plant and a potting apparatus, the potting apparatus comprising a sleeve and a plug of potting media, wherein roots of the plant are disposed at least partially within the sleeve and pass through one or more apertures of the sleeve; and
a container device that at least partially contains the planting assembly, the container device having:
a first side panel;
a second side panel;
a third side panel;
a fourth side panel;
a first corner support;
a second corner support;
a third corner support; and
a fourth corner support;
wherein the first side panel, the second side panel, the third side panel, and the fourth side panel define an interior space configured to receive at least part of the planting assembly, and
wherein the first corner support, the second corner support, the third corner support, and the fourth corner support are configured to contact and support a planting apparatus of the planting assembly.

9. The plant system according to claim 8, wherein the first corner support is defined at least in part by a curved cut.

10. The plant system according to claim 8, wherein the first corner support comprises a folded diamond shape.

11. The plant system according to claim 10, wherein the folded diamond shape comprises a seam disposed between a first triangle half and a second triangle half, wherein the first triangle half comprises a first base disposed along the seam, a first side, and a second side, and wherein the second triangle half comprises a second base disposed along the seam, a first side, and a second side.

12. The plant system according to claim 11, wherein the first side of the first triangle half has a lower portion that connects with a lower portion of the first side panel, and wherein the first side of the second triangle half has a lower portion that connects with a lower portion of the second side panel.

13. The plant system according to claim 11, wherein the first side of the first triangle half has a lower portion that connects with a central portion of the first side panel that is disposed above a lower portion of the first side panel, and wherein the first side of the second triangle half has a lower portion that connects with a central portion of the second side panel that is disposed above a lower portion of the second side panel.

14. The plant system according to claim 8, wherein the container device further comprises a platform that is supported by the first corner support, the second corner support, the third corner support, and the fourth corner support.

15. A method of producing a plant system, the method comprising:
placing a planting assembly at least partially within a container device, wherein the container device comprises:
a first side panel;
a second side panel;
a third side panel;
a fourth side panel;
a first corner support;
a second corner support;
a third corner support; and
a fourth corner support;
wherein the first side panel, the second side panel, the third side panel, and the fourth side panel define an interior space configured to receive at least part of the planting assembly, and
wherein the first corner support, the second corner support, the third corner support, and the fourth corner support are configured to contact and support a planting apparatus of the planting assembly.

16. The method according to claim 15, wherein the first corner support is defined at least in part by a curved cut.

17. The method according to claim 15, wherein the first corner support comprises a folded diamond shape.

18. The method according to claim 17, wherein the folded diamond shape comprises a seam disposed between a first triangle half and a second triangle half, wherein the first triangle half comprises a first base disposed along the seam, a first side, and a second side, and wherein the second triangle half comprises a second base disposed along the seam, a first side, and a second side.

19. The method according to claim 17, wherein the first side of the first triangle half has a lower portion that connects with a lower portion of the first side panel, and wherein the first side of the second triangle half has a lower portion that connects with a lower portion of the second side panel.

20. The method according to claim 17, wherein the first side of the first triangle half has a lower portion that connects with a central portion of the first side panel that is disposed above a lower portion of the first side panel, and wherein the first side of the second triangle half has a lower portion that connects with a central portion of the second side panel that is disposed above a lower portion of the second side panel.
